(19) United States
(12) Patent Application Publication
(10) Pub. No.: US 2020/0396765 A1
(43) Pub. Date: Dec. 17, 2020

(54) METHODS AND DEVICES FOR DATA TRANSMISSION ON UNLICENSED BAND IN A WIRELESS COMMUNICATION SYSTEM

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 16/763,128

(22) PCT Filed: Nov. 13, 2017
(86) PCT No.: PCT/CN2017/110721

§ 371 Date: May 11, 2020

(51) Int. Cl. H04W 74/08; H04W 16/14; H04L 5/00

(52) U.S. Cl. CPC H04W 74/0808; H04W 16/14; H04L 5/0057; H04L 5/0048; H04L 5/0023

(57) ABSTRACT

Embodiments of the present disclosure relate to methods, devices and apparatus for data transmission on an unlicensed band in a wireless communication system. In an embodiment of the present disclosure, a method may include transmitting a channel assessment feedback request to a destination device after a successful CCA on the unlicensed band, wherein the channel assessment feedback request contains at least one of configuration information on the channel assessment feedback request and configuration information on a channel assessment feedback in a common control information region; and receiving, from the destination device, a channel assessment feedback indicating channel state measured by the destination device, wherein the data transmission on the unlicensed band is dependent on the measured channel state. With embodiments of the present disclosure, it is possible to balance transmission efficiency and interference avoidance in the wireless communication system like the NR system.

### FIELD OF THE INVENTION

The non-limiting and exemplary embodiments of the present disclosure generally relate to the field of wireless communication techniques, and more particularly relate to methods, devices and apparatuses for data transmission on unlicensed band in a wireless communication system.

### BACKGROUND OF THE INVENTION

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

In order to improve the data rate performance, in 3GPP Long Term Evolution (LTE), there was introduced License Assisted Access (LAA) for both downlink and uplink transmission. As the LTE network enters its next phase of evolution with the study of wider bandwidth waveform under the NR project, it is natural for the LAA networks to evolve into the 5G NR system. Many features (like Clear Channel Access (CCA), Listen Before Talk (LBT) mechanism, etc.) used in LAA in the LTE system may be maintained due to the similarity between the NR unlicensed band and the LTE unlicensed band. However, there are also some obvious differences, one of which lies in the NR system supporting the high frequency deployment up to 60 GHz, which might cause a serious hidden node issue.

For illustrative purposes, FIG. 1 illustrates a scenario in the LTE network which might raise a hidden node issue. As illustrated in FIG. 1, node B and node C are hidden nodes to each other since they are out of sensing range and cannot detect each other. Thus, when node B is sending a packet to node A, node C cannot sense the transmission. In this case, node C might transmit data at the same time and thus causes interferences to the transmission from node B to node A, which is called as the hidden node issue.

In LAA, the hidden node issue can be solved by Channel State Information (CSI) measurement and reporting, for example, Received Signal Strength Indicator (RSRI) or Reference Signal Received Quality (RSRQ) measurement and reporting. Based the measurement and reporting, potential collision scheduling can be avoided implicitly. The LBT on unlicensed band is a mechanism adopted in LAA, wherein a channel clear access is needed before transmitting. By means of LBT, a plenty of interference collisions can be also avoided because when a clear channel access fails, no transmission happens and no undesirable interference is introduced.

However, in the NR system, a large number of antennas are introduced for directional beam forming so as to compensate large pass loss attenuation. Thus, the coverage changes from traditional omni-direction to a beam like direction, as illustrated in FIG. 2. Different from wide beam broadcasting solution used at the low frequency, the directional beam in the NR system might cause a much serious hidden node issue, which might in turn raise the collision probability.

FIG. 3 illustrates a scenario in the NR system which might raise the hidden node issue. As illustrated in FIG. 3, antenna ANT2 will first listen before it transmits data to user equipment (UE) 2, while ANT1 is out of the sensing region and thus ANT2 cannot sense the transmission between ANT 1 and UE 1. Thus, even if ANT 2 performs a LBT operation, it cannot sense the transmission between ANT 1 and UE1, which would cause a hidden node issue if ANT 2 transmits data to UE 2 at the same time.

Therefore, as the carrier frequency becomes higher and the beam becomes narrower, the hidden node issue becomes more complex. Meanwhile, if the RSRI or RSRQ measurement and reporting is used, CSI measurement will require more CSI resources since more directions need to be listened. Frequent measurement signal transmission might not cause a substantial problem in the licensed band, but in unlicensed band, it would cause a transmission collision or interference to other users or other systems. This could be unfair for other users or systems, and moreover, the network node in NR system might become a bad neighbor for a frequent signal transmission case while it might be hard to trace real time channel quality for a seldom signal transmission case.

Thus, a new solution is required to address the hidden node issue.

### SUMMARY OF THE INVENTION

To this end, in the present disclosure, there is provided a new solution for data transmission on an unlicensed band in a wireless communication system, to mitigate or at least alleviate at least part of the issues in the prior art.

According to a first aspect of the present disclosure, there is provided a method for data transmission on an unlicensed band in a wireless communication system. The method may be performed at an originating device of the data transmission. For the downlink data transmission, the originating device could be a network node like base station in the NR system (gNB), or other network devices. For an uplink data transmission, the originating device could be a terminal device, for example UE, or other like terminal devices. The method may comprise transmitting a channel assessment feedback request to a destination device after a successful Clear Channel Access (CCA) on the unlicensed band. The channel assessment feedback request may contain at least one of configuration information on the channel assessment feedback request and configuration information on a channel assessment feedback in a common control information region. The method may further comprise receiving, from the destination device, a channel assessment feedback indicating channel state measured by the destination device on the unlicensed band, wherein the data transmission on the unlicensed band is dependent on the channel state indicated by the channel assessment feedback.

According to a second aspect of the present disclosure, there is provided another method for data transmission on an unlicensed band in a wireless communication system. The method may be performed at a destination device of the data transmission. For a downlink data transmission, the destination device could be a terminal device, for example UE, or other like terminal devices. For an uplink data transmission, the destination device could be a network node like gNB, or other network devices. The method may comprise receiving a channel assessment feedback request from an originating device. The channel assessment feedback request may contain at least one of configuration information on the channel assessment feedback request and configuration information on a channel assessment feedback in a common control information region. The method may further comprise measuring, in response to the channel assessment feedback request, channel state on the unlicensed band; and transmitting, to the originating device, a channel assessment feedback indicating the channel state measured by the destination device on the unlicensed band, wherein the data transmission from the originating device is dependent on the channel state indicated by the channel assessment feedback.

According to a third aspect of the present disclosure, there is provided an originating device of data transmission on an unlicensed band in wireless communication system. For the downlink data transmission, the originating device could be a network node like gNB, or other network devices. For an uplink data transmission, the originating device could be a terminal device, for example UE, or other like terminal devices. The originating device may comprise a transceiver. The transceiver may be configured to transmit a channel assessment feedback request to a destination device after a successful Clear Channel Access (CCA) on the unlicensed band. The channel assessment feedback request contains at least one of configuration information on the channel assessment feedback request and configuration information on a channel assessment feedback in a common control information region. The transceiver may be further configured to receive, from the destination device, a channel assessment feedback indicating channel state measured by the destination device on the unlicensed band, wherein the data transmission on the unlicensed band is dependent on the channel state indicated by the channel assessment feedback.

According to a fourth aspect of the present disclosure, there is provided a destination device of data transmission on an unlicensed band in wireless communication system. For a downlink data transmission, the destination device could be a terminal device, for example UE, or other like terminal devices. For an uplink data transmission, the destination device could be a network node like gNB, or other network devices. The destination device may comprise a transceiver. The transceiver may be configured to receive a channel assessment feedback request from an originating device, wherein the channel assessment feedback request contains at least one of configuration information on the channel assessment feedback request and configuration information on a channel assessment feedback in a common control information region. The destination device may further comprise a processor, configured to measure, in response to the channel assessment feedback request, channel state on the unlicensed band. The transceiver may be further configured to transmit, to the originating device, a channel assessment feedback indicating the channel state measured by the destination device on the unlicensed band, wherein the data transmission from the originating device is dependent on the channel state indicated by the channel assessment feedback.

According to a fifth aspect of the present disclosure, there is provided an originating device of data transmission on an unlicensed band in wireless communication system. For the downlink data transmission, the originating device could be a network node like gNB, or other network devices. For an uplink data transmission, the originating device could be a terminal device, for example UE, or other like terminal devices. The originating device may comprise a processor and a memory. The memory may be coupled with the processor and having program codes therein, which, when executed on the processor, cause the terminal device to perform operations of the first aspect.

According to a sixth aspect of the present disclosure, there is provided a destination device of data transmission on an unlicensed band in wireless communication system. For a downlink data transmission, the destination device could be a terminal device, for example UE, or other like terminal devices. For an uplink data transmission, the destination device could be a network node like gNB, or other network devices. The destination device may comprise a processor and a memory. The memory may be coupled with the processor and have program codes therein, which, when executed on the processor, cause the network node to perform operations of the second aspect.

According to a seventh aspect of the present disclosure, there is provided a computer-readable storage media with computer program codes embodied thereon, the computer program codes configured to, when executed, cause an apparatus to perform actions in the method according to any embodiment in the first aspect.

According to an eighth aspect of the present disclosure, there is provided a computer-readable storage media with computer program codes embodied thereon, the computer program codes configured to, when executed, cause an apparatus to perform actions in the method according to any embodiment in the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, it is possible to provide a fast channel assessment feedback mechanism that can balance transmission efficiency and interference avoidance in the wireless communication system like the NR system.

### BRIEF DESCRIPTION OF THE DRAWINGS

The above and other features of the present disclosure will become more apparent through detailed explanation on the embodiments as illustrated in the embodiments with reference to the accompanying drawings, throughout which like reference numbers represent same or similar components and wherein:

FIG. 1 illustrates a scenario in the LTE system which might raise a hidden node issue;

FIG. 2 schematically illustrates converge in beam like direction in the NR system;

FIG. 3 illustrates a scenario in the NR system which might raise a hidden node issue;

FIG. 4 schematically illustrates an example frame structure for downlink data transmission according to an embodiment of the present disclosure;

FIG. 5 schematically illustrates an example frame structure for uplink data transmission according to an embodiment of the present disclosure;

FIG. 6 schematically illustrates another example frame structure for uplink data transmission according to an embodiment of the present disclosure;

FIG. 7 schematically illustrates a flow chart of a method for data transmission on an unlicensed band in a wireless communication system according to an embodiment of the present disclosure;

FIG. 8 schematically illustrates an example frame structure for downlink data transmission according to an embodiment of the present disclosure;

FIG. 9 schematically illustrates an example frame structure in Quasi-colocation (QCL) mode of channel assessment feedback request according to an embodiment of the present disclosure;

FIG. 10 schematically illustrates an example frame structure in CSI-RS mode of channel assessment feedback request according to an embodiment of the present disclosure;

FIG. 11 schematically illustrates an example frame structure in data mode of channel assessment feedback request according to an embodiment of the present disclosure;

FIG. 12 schematically illustrates an example frame structure in no confirm-ACK mode of channel assessment feedback according to an embodiment of the present disclosure;

FIG. 13 schematically illustrates an example frame structure in a beam sweeping mode of channel assessment feedback according to an embodiment of the present disclosure;

FIG. 14 schematically illustrates an example frame structure in an aligned transmission mode according to embodiments of the present disclosure;

FIG. 15 schematically illustrates an example frame structure in an unaligned transmission according to embodiments of the present disclosure;

FIG. 16 schematically illustrates an example frame structure for downlink data transmission in differential CQI feedback mode according to embodiments of the present disclosure;

FIG. 17 schematically illustrates an example frame structure for uplink data transmission in differential Chanel Quality Information (CQI) feedback mode according to embodiments of the present disclosure;

FIG. 18A schematically illustrates another scenario in the NR system which might raise a hidden node issue according to an embodiment of the present disclosure;

FIG. 18B schematically illustrates a diagram of channel assessment feedback transmission in beam sweeping mode according to an embodiment of the present disclosure;

FIG. 19 schematically illustrates a flow chart of a method for data transmission on an unlicensed band in a wireless communication system according to an embodiment of the present disclosure;

FIG. 20 schematically illustrates a block diagram of an apparatus for data transmission on an unlicensed band in a wireless communication system according to an embodiment of the present disclosure;

FIG. 21 schematically illustrates a block diagram of an apparatus for data transmission on an unlicensed band in a wireless communication system according to an embodiment of the present disclosure;

FIG. 22 schematically illustrates a simplified block diagram of an apparatus 2210 that may be embodied as or comprised in an originating device of data transmission on an unlicensed band, and an apparatus 2220 that may be embodied as or comprised in a destination device of data transmission on the unlicensed band UE as described herein.

### DETAILED DESCRIPTION OF EMBODIMENTS

Hereinafter, the solution as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc.]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, user equipment (UE) may refer to a terminal, a Mobile Terminal (MT), a subscriber station, a portable subscriber station, Mobile Station (MS), or an Access Terminal (AT), and some or all of the functions of the UE, the terminal, the MT, the SS, the portable subscriber station, the MS, or the AT may be included. Furthermore, in the context of the present disclosure, the term “BS” may represent, e.g., a node B (NodeB or NB), an evolved NodeB (eNodeB or eNB), gNB (next generation Node B), a radio header (RH), a remote radio head (RRH), a relay, or a low power node such as a femto, a pico, and so on.

As mentioned in background, as the carrier frequency becomes higher and the beam becomes narrower, the hidden node issue becomes more complex. In the existing solutions, there are some discussions on the hidden node issue. For example, in Chinese patent application publication CN105230109A, there was proposed a solution based on request-to-send signal and common or individual clear-to-send signals. In U.S. Pat. No. 9,763,267B2, there was also proposed a solution based on a request-to-send signal and one or more clear-to-send signals. In 3GPP technology document R1-150404, the hidden node issue was also discussed and it was proposed to consider UE detection of dominant interfering hidden node and not to use the request-to-send/clear-to-send signaling for inter-system detection. However, these existing solutions cannot be directly used to address the hidden node issue in the NR system and a new solution is required.

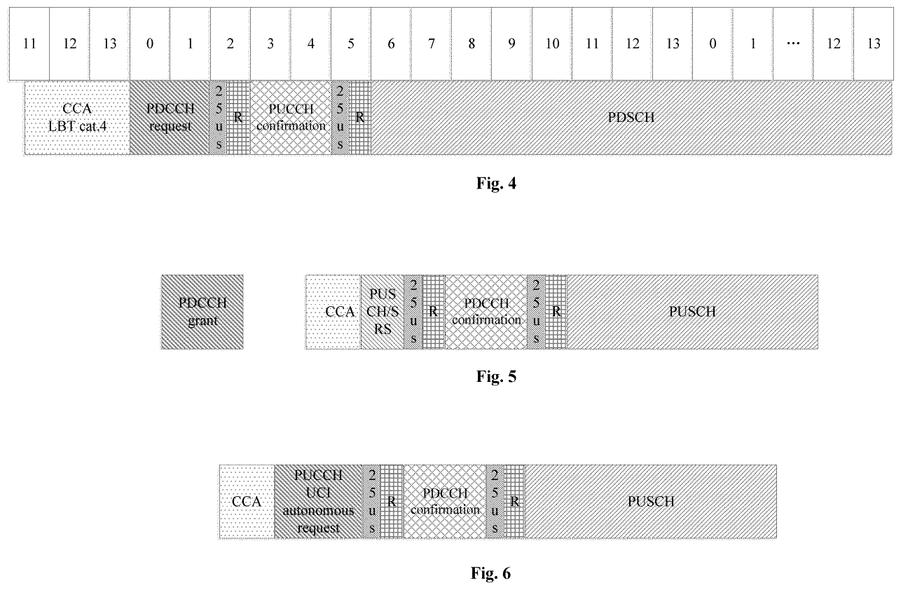

To this end, in the present disclosure, there is proposed a new solution for data transmission on the unlicensed band, which could mitigate or at least alleviate at least part of the issues in the prior art. Hereinafter, reference will be further made to accompanying drawings to describe the solutions as proposed in the present disclosure in details. However, it shall be appreciated that the following embodiments are given only for illustrative purposes and the present disclosure is not limited thereto. Reference will be first made to FIGS. 4 to 6 to describe the basic idea of the new solution for downlink data transmission and uplink data transmission on the unlicensed band.

FIG. 4 schematically illustrates an example frame structure for downlink data transmission according to an embodiment of the present disclosure. As illustrated in FIG. 4, for a downlink data transmission, after a successful CCA (for example LBT cat. 4), the gNB may transmit a channel assessment feedback request signal on Physical Downlink Control Channel (PDCCH) with possible additional CSI-RS resource or Physical Downlink Shared Channel (PDSCH) resource. In response to the channel assessment feedback request signal from the gNB, UE may send a channel assessment feedback to the gNB. The channel assessment feedback could be carried on, for example, PUCCH, with a deferral interval of 25 μs (LBT cat. 2 CCA). Based on the channel assessment feedback (for example. a confirm ACK), the gNB could decide to transmit data on the PDSCH. The downlink data transmission can be performed for example after an LBT cat. 2 CCA (with a defer interval 25 μs), or be performed directly. Moreover, based on a channel assessment feedback (for example, a confirmation-NACK or DTX), the gNB could decide to stop data transmission or adjust data transmission on PDSCH.

FIG. 5 schematically illustrates an example frame structure for uplink data transmission according to an embodiment of the present disclosure. In FIG. 5 is illustrated a scheduling-based uplink data transmission case wherein the gNB schedules transmission resources for the uplink data transmission. Thus, a PDCCH grant is first transmitted to inform the UE of the scheduled resources. Then, after a successful CCA (LBT cat. 4), the gNB may transmit a channel assessment feedback request on Physical Uplink Control Channel (PUSCH), or the channel assessment feedback request may comprise a sounding reference signal (SRS). In response to the channel assessment feedback request signal from the UE, the gNB may send back a channel assessment feedback to the UE. The channel assessment feedback could be carried on, for example, PDCCH with a deferral interval of 25 μs (LBT cat. 2 CCA). Based on the channel assessment feedback (for example a confirm ACK), the UE could transmit data on the PUSCH. The uplink data transmit can be performed for example after an LBT cat. 2 CCA (with a defer interval 25 μs), or be performed directly.

FIG. 6 schematically illustrates another example frame structure for uplink data transmission according to an embodiment of the present disclosure. In FIG. 6 is an autonomous uplink data transmission case, wherein the uplink data transmission resources are selected by the UE autonomously. The difference from the frame structure as illustrated in FIG. 5 lies in that no PDCCH grant is transmitted from the gNB and an autonomous channel assessment feedback request is transmitted on for example PUCCH, instead of a channel assessment feedback request on PUSCH or SRS.

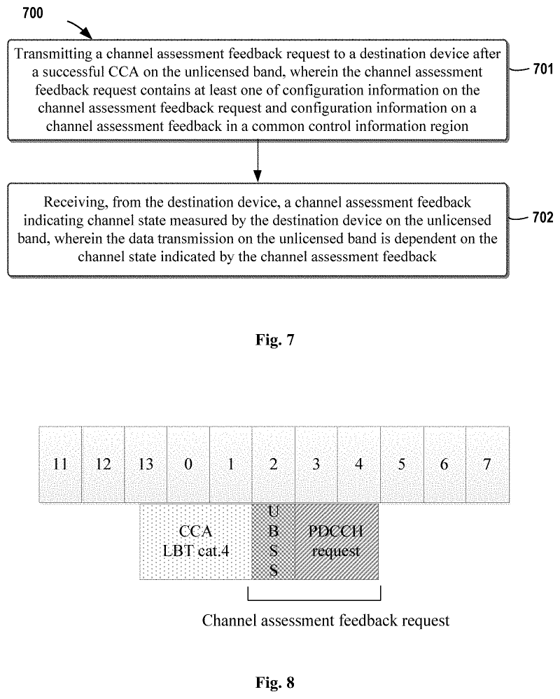

Next, reference will be made to FIGS. 7 to 22 describe details of operations on the originating device and the destination device of the data transmission. It shall be noticed that for illustrative purposes, the downlink data transmission will be taken as an example. However, the skilled in the art can understand that the solution of uplink data transmission is similar to that of downlink data transmission except resource scheduling, channels carrying request and feedback, and channel reservation requirements, and thus most of the description can apply to the uplink data transmission as well.

Hereinafter, terms “originating device” and “destination device” are used, which respectively means the data transmitting device and data receiving device of the data transmission on the unlicensed band. For a downlink data transmission, the originating device could be a network node like gNB, or other network devices, and the destination device could be a terminal device, for example UE, or other like terminal devices. For an uplink data transmission, the originating device could be a terminal device, for example UE, or other like terminal devices, and the destination device could be a network node like gNB, or other network devices.

FIG. 7 illustrates a flow chart of a method 700 for data transmission on the unlicensed band in a wireless communication system according to an embodiment of the present disclosure. The method 700 can be performed at an originating device. For the downlink data transmission, the originating device could be a network node like gNB, or other network devices; for an uplink data transmission, the originating device could be a terminal device, for example UE, or other like terminal devices.

As illustrated in FIG. 7, in step 701, the originating device may transmit a channel assessment feedback request to a destination device after a successful Clear Channel Access (CCA) on the unlicensed band. The channel assessment feedback request is used to ask the destination device to perform channel assessment on the unlicensed band and it may contain at least one of configuration information on the channel assessment feedback request and configuration information on a channel assessment feedback in a common control information region.

The configuration information on the channel assessment feedback request may include any configuration regarding the channel assessment feedback request. For example, the configuration information on the channel assessment feedback request may comprise at least one of a category of the channel assessment feedback request and transmission resources of the channel assessment feedback request.

In an embodiment of the present disclosure, it may include a category of the channel assessment feedback request. The PDCCH carrying the channel assessment feedback request may adopt cat. 4 LBT with exponent back off and could start from a slot boundary, or start from any symbol of the frame. Thus, the category of the channel assessment feedback request may indicate whether the channel assessment feedback request support unaligned transmission. The unaligned transmission herein means a feedback request transmission starting from other symbols than the slot boundary.

In a case of unaligned transmission, the channel assessment feedback request may further contain an unlicensed band synchronization signal (UBSS) for time alignment. FIG. 8 schematically illustrates an example frame structure for downlink data transmission according to an embodiment of the present disclosure. As illustrated in FIG. 8, the channel assessment feedback request starts from symbol 2 instead of symbol 0, and before the control information on PDCCH, there is further inserted a UBSS for time alignment.

As another example, the channel assessment feedback request may further include three different categories of channel assessment feedback request, i.e., a) Quasi-colocation (QCL) mode, b) reference signal (RS) mode, and c) data mode. In the QCL mode, the control channel and data channel are quasi-colocated (QCLed) and thus have substantially similar channel quality. Thus, the data channel quality can be assessed as the control channel quality. In such a case, the channel assessment feedback request may comprise only control information on PDCCH without any of reference signals or code data. In RS mode and data mode, the data channel has different quality from the control channel and thus additional Channel State Information-Reference Signal (CSI-RS) or coded data is further transmitted to measure the data channel.

For illustrative purposes, Table 1 gives an example table of category configuration of the channel assessment feedback request for downlink data transmission.

TABLE 1
Example configuration of the channel assessment feedback request

| Configuration Field | Configuration |
|---|---|
| 00 | 0 OFDM symbol following control resource set (CORESET), and |
| | PDSCH is QCLed with PDCCH |
| 01 | 2 OFDM symbols following CORESET, and CSI-RS is transmitted |
| | for channel assessment feedback |
| 10 | 4 OFDM symbols following CORESET, and encoded data is |
| | transmitted for channel assessment feedback |
| 11 | reserved |

In the Table 1, configuration “00” corresponds to QCL mode, configuration “01” corresponds to RS mode; and configuration “10” corresponds to data mode and it further illustrates transmission resources for different modes.

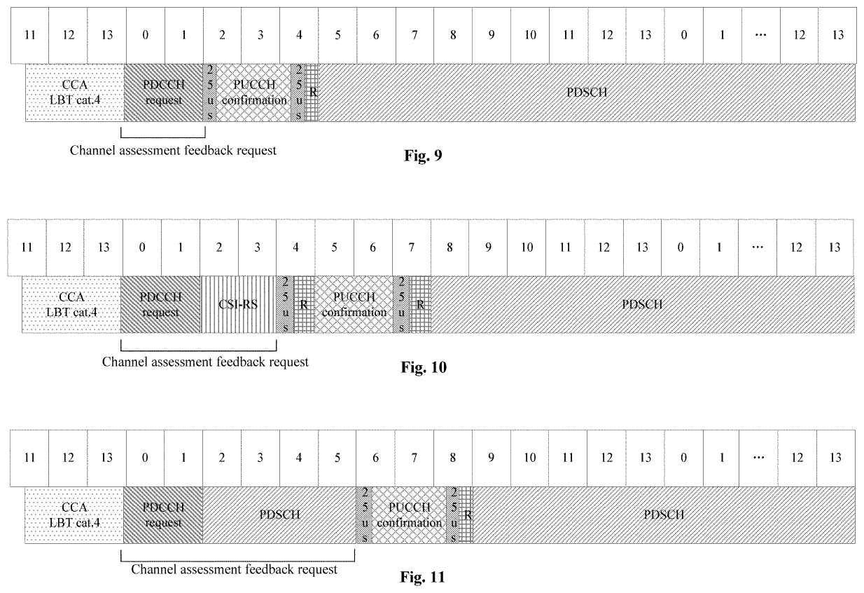

FIGS. 9 to 11 illustrate example frame structures in the above three different categories according to embodiments of the present disclosure. FIG. 9 schematically illustrates of an example frame structure in QCL mode of channel assessment feedback request according to an embodiment of the present disclosure. As illustrated in FIG. 9, the channel assessment feedback request may comprise only control information on PDCCH, which corresponds to configuration “00”. FIG. 10 schematically illustrates of an example frame structure in CSI-RS mode of channel assessment feedback request according to an embodiment of the present disclosure. As illustrated in FIG. 10, the channel assessment feedback request may further comprise CSI-RS (2 symbols) in addition to control information on PDCCH, which corresponds to configuration “01”. FIG. 11 schematically illustrates of an example frame structure in data mode of channel assessment feedback request according to an embodiment of the present disclosure. As illustrated in FIG. 11, the channel assessment feedback request may further comprise coded data (4 symbols) on PDSCH in addition to control information on PDCCH, which corresponds to configuration “10”.

In another embodiment of the present disclosure, the configuration information on the channel assessment feedback request may include transmission resources of the channel assessment feedback request. For example, it may contain the number of symbols occupied by the channel assessment feedback request so that the UE could know the end position of the channel assessment feedback request.

In an embodiment of the present disclosure, the configuration information on the channel assessment feedback may include any configuration regarding the channel assessment feedback. For example, the configuration information on the channel assessment feedback may comprise at least one of a category of the channel assessment feedback and transmission resources for the channel assessment feedback.

In another embodiment of the present disclosure, the configuration information on the channel assessment feedback may indicate a specific category of the channel assessment feedback. For example, it may indicate whether the channel assessment feedback is needed. As another example, it may indicate whether the channel assessment feedback supports unaligned transmission or not. As a further example, it may indicate whether beam sweeping feedback mode is enabled wherein one or more directional channel assessment feedbacks are transmitted back to the gNB on one or more beams. As a still further example, it may further indicate the content type of the channel assessment feedback, for example, a confirmation-ACK or differential CQI. For illustrative purposes, Table 2 illustrates a configuration table for the channel assessment feedback.

TABLE 2
Example configuration of the channel assessment feedback

| Configuration Field | Configuration |
|---|---|
| 00 | No fast feedback channel sensing (no confirm-ACK) |
| 01 | 4 OFDM symbols aligned PUCCH confirm-ACK feedback |
| 10 | 3 OFDM symbols unaligned PUCCH confirm-ACK feedback |
| 11 | Beam sweeping of PUCCH confirm-ACK |

It shall be noticed that the configurations given in Table 2 are just given for illustrative purposes, the present disclosure is not limited thereto. In fact, more categories can be added; some of them can be removed; the table can be divided into a plurality of tables; or the table can also contain more columns indicates more information like resource allocation, etc.

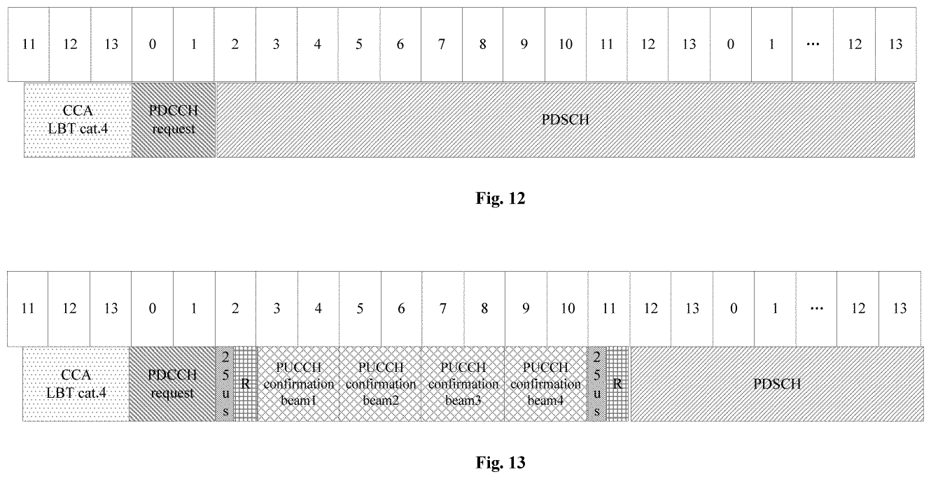

FIGS. 12 and 13 respectively illustrate example frame structures in different categories according to embodiments of the present disclosure. FIG. 12 schematically illustrates an example frame structure in no confirm-ACK mode of channel assessment feedback according to an embodiment of the present disclosure. As illustrated in FIG. 12, the channel assessment feedback is not required before data transmission on PDSCH, which corresponds to configuration “00”. FIG. 13 schematically illustrates an example frame structure in a beam sweeping mode of channel assessment feedback according to an embodiment of the present disclosure. As illustrated in FIG. 13, the channel assessment feedback contains four directional channel assessment feedbacks transmitted on beams 1 to 4, which corresponds to configuration “11”.

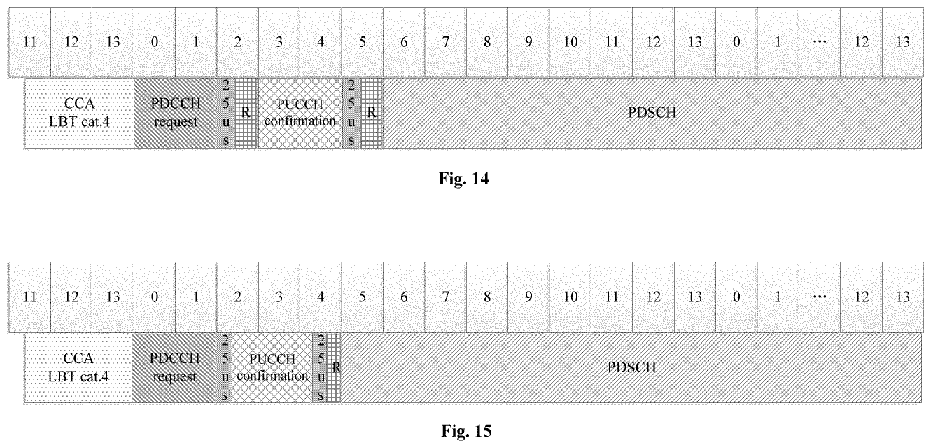

For illustrative purposes, FIG. 14 and FIG. 15 further illustrate example frame structures in aligned transmission mode and in unaligned transmission mode according to embodiments of the present disclosure. As illustrated in FIG. 14, the channel assessment feedback only supports aligned transmission, and the PUCCH confirmation transmission starts from the start boundary of symbol 3; on the contrary, in FIG. 15, the channel assessment feedback supports unaligned transmission ,and the PUCCH confirmation transmission starts in symbol 2, immediately after 25 us delay without any further waiting. In case of unaligned transmission, UBSS may be further inserted before the PUCCH confirmation for time alignment.

In addition, channel measurement activation information can be contained in the channel assessment feedback request to indicate whether the channel assessment feedback is active for the destination device. For example, one bit in Downlink Control information (DCI) can be used to carry the channel measurement activation information. As another example, the channel measurement activation information can also be carried through a higher layer (e.g., Media Access Control (MAC) Control Element (CE) or Radio Resource Control (RRC) signaling).

For the downlink scheduling, when the channel measurement activation information indicates that the channel assessment feedback is active for the destination device and the data transmission is to be scheduled in slot n, the control information in the common region is expected in slot n. If the UE cannot decode the control information in the common region and the UE will not receive any data on slot n. For the uplink scheduling, the channel measurement activation information can be contained in the PDCCH grant, or separately transmitted to the UE through the higher layer.

The common region may further comprise scheduling DCI, which may contain for example Modulation and Coding Scheme (MCS) level, Hybrid Automatic Repeat Request (HARQ) identity, codewords, and other information usually contained in the scheduling DCI. The common region could be scrambled by common group cell-specific identity such as Common Cell Radio Network Temporary Identifier (CC-RNTI). The control resource set containing scheduling DCI and group common DCI can adopt a cat.4 LBT, i.e. LBT with exponent back off, and it may start from slot boundary or any symbol. In addition, it may further comprise duration information for the data transmission.

It can be understood that other network node may receive control information in the common control region and learn the duration information for the data transmission. Thus, it may provide an opportunity for the other network node to stop transmission during the duration of the data transmission to avoid interference.

Reference is made back to FIG. 7, and in step 702, the originating device may receive, from the destination device, a channel assessment feedback indicating channel state measured by the destination device on the unlicensed band. The originating device may perform the data transmission on the unlicensed band dependent on the channel state indicated by the channel assessment feedback.

The channel assessment feedback may be in any suitable form. In an embodiment of the represent disclosure, the channel assessment feedback comprises acknowledge that confirms a good channel state on the unlicensed band. That is to say, if the destination device could decode the information contained in the channel assessment feedback request successfully, it will send an ACK to the originating device; otherwise a NACK is fed back, or alternatively no any response is transmitted. For a downlink data transmission, if an ACK is received from the UE, the gNB may transmit the remaining data based on the scheduling. The data transmission may also adopt a cat. 2 LBT. However, if the feedback is a NACK, or DTX, the gNB stops the remaining data transmission.

In another embodiment of the present disclosure, the channel assessment feedback comprises differential CQI. The differential CQI may indicate a difference between initially indicated channel quality and channel quality measured by the destination device. For example, the destination device cannot decode successfully with the MCS level as initially indicated in the scheduling DCI but can decode successfully with MCS level lower than the initially indicated MCS level. In such a case, the destination device could feed back the MCS level difference as the differential CQI to the originating device. Upon receipt of such differential CQI, the originating device may transmit the data on the unlicensed band at the channel quality measured by the destination device.

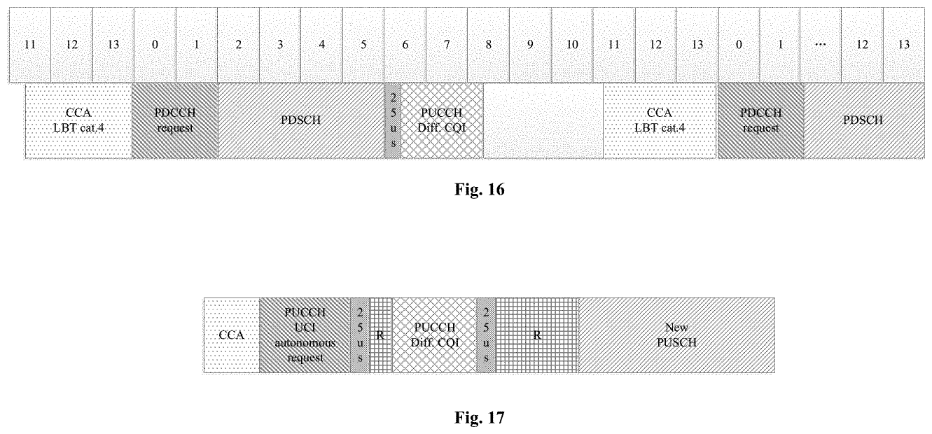

FIG. 16 schematically illustrates an example frame structure for data downlink transmission in differential CQI feedback mode according to embodiments of the present disclosure. As illustrated in FIG. 16, the UE may transmit differential CQI as channel assessment feedback on PUCCH back to the gNB. Upon receipt of such differential CQI, the gNB could re-schedule the resource for the data transmission based on the reported differential CQI. After a successful LBT cat. 4 CCA operation, the gNB may optionally transmit another channel assessment feedback request to inform the successful scheduling and transmit the remaining data directly without waiting any feedback.

FIG. 17 schematically illustrates an example frame structure for uplink data transmission in differential CQI feedback mode according to an embodiment of the present disclosure. As illustrated in FIG. 17, the gNB may transmit differential CQI as channel assessment feedback on PDCCH back to the UE. Upon receipt of such differential CQI, the UE could send reservation signals on the unlicensed and meanwhile determine transmission resources for the data transmission based on the reported differential CQI. Then, the UE may begin the data transmission on the PUSCH with the new transmission resource.

On the other hand, if it is impossible to decode successfully, the different CQI is too negative, the originating device may just ignore the differential CQI and prepare new transmission resource for the data transmission. For example, for the downlink data transmission, gNB could stop transmission and prepare a new scheduling for the down link transmission; for the uplink transmission, UE can prepare a new PUSCH transmission depending on UE's capability for uplink transmission.

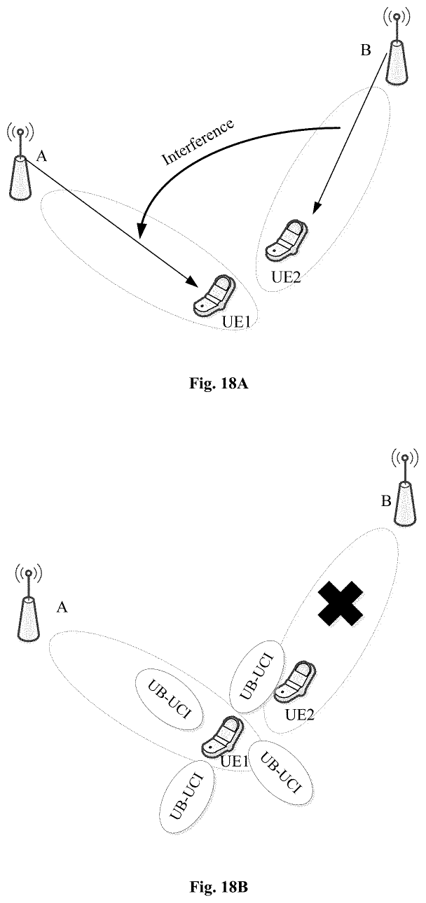

By means of the above-mentioned solution, it is possible to avoid interference to other ongoing transmission; however, such a solution can not address the interference from other nodes. As illustrated in FIG. 18A, node A could use the solution as proposed herein to avoid transmission when node B is transmitting data to UE 2, the interference from node B cannot be avoided actively if the transmission is ongoing between node A and UE 1. In other words, Node B might still transmit data to UE 2 while the transmission is ongoing between node A and UE 1.

In the present disclosure, it is further proposed to scramble the channel assessment feedback by an unlicensed band identity (for example, UB-RNTI) and contain duration information for the data transmission in the channel assessment feedback. The UB-RNTI may have a small number, like 3 and it can be used to generate DMRS sequence and scramble the unlicensed band control information. That means all NR unlicensed band stations (including gNB and terminal devices) can decode the information in unlicensed band downlink control information (UB-DCI) or unlicensed band uplink control information (UB-UCI). Moreover, the scrambling and the duration information can be applied for both UB-DCI and UB-UCI. In such a way, before the transmission starts between node A and UE 1, Node B can learn the transmission and avoid a transmission to UE 2 during the transmission between Node A and UE1.

In addition, the channel assessment feedback may also have UBSS inserted before the UB-DCI and UB-UCI for time alignment, wherein the sequence for UBSS generated by UB-RNTI could be same as that for UB-DCI or UB-UCI. Moreover, it is also possible to trigger the beam sweeping mode of the channel assessment feedback. As illustrated in FIG. 18B, one or more directional channel assessment feedback can be transmitted on one or more beams. In other words, the channel assessment feedback may contain one or more directional channel assessment feedbacks. The number of beams can be configured in the channel assessment feedback request. In such a way, interference on respective beams can be actively avoided.

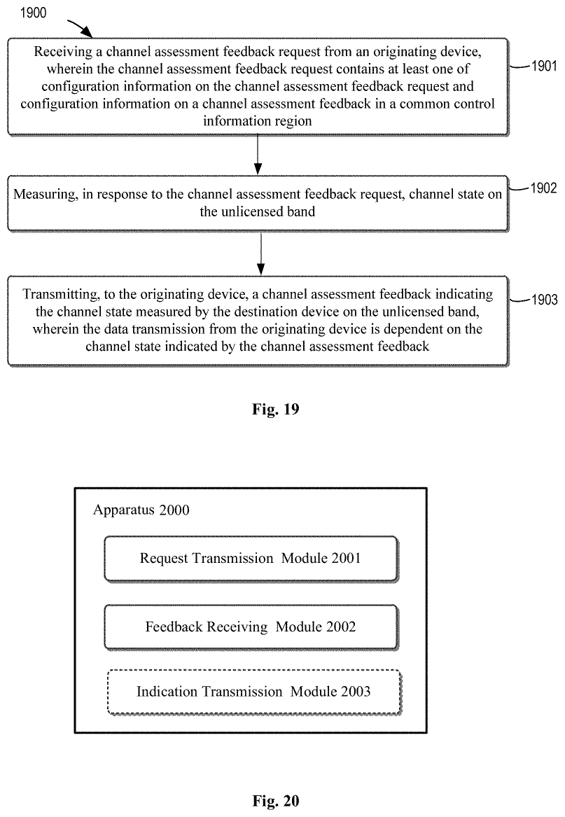

Hereinbefore, solutions for data transmission on an unlicensed band at the originating side are described with reference to FIGS. 7 to 18, and next, solutions for data transmission on an unlicensed band at the destination side will be described with reference to FIG. 19.

FIG. 19 schematically illustrates a flow chart of a method for data transmission on an unlicensed band in a wireless communication system according to an embodiment of the present disclosure. The method 1900 can be performed at a destination device. For a downlink data transmission, the destination device could be a terminal device, for example UE, or other like terminal devices; for an uplink data transmission, the destination device could be a network node like gNB, or other network devices.

As illustrated in FIG. 19, in step 1901, the destination device may receive a channel assessment feedback request from an originating device. The channel assessment feedback request is used to ask the destination device to perform channel assessment on the unlicensed band and it may contain at least one of configuration information on the channel assessment feedback request and configuration information on a channel assessment feedback in a common control information region.

In an embodiment of the present disclosure, the configuration information on the channel assessment feedback request may include any configuration regarding the channel assessment feedback request. For example, the configuration information on the channel assessment feedback request may comprise at least one of a category of the channel assessment feedback request and transmission resources of the channel assessment feedback request. The category of the channel assessment feedback request may indicate one or more of: whether the channel assessment feedback request starts from any symbol of the frame; whether the channel assessment feedback request include UBSS, which request mode the channel assessment feedback request uses, a) Quasi-colocation (QCL) mode, b) reference signal (RS) mode, or c) data mode, for example as illustrated in Table 1 and FIGS. 8 to 11.

In another embodiment of the present disclosure, the configuration information on the channel assessment feedback request may include transmission resources of the channel assessment feedback request. For example, it may contain the number of symbols occupied by the channel assessment feedback request so that the UE could know the end position of the channel assessment feedback request.

In an embodiment of the present disclosure, the configuration information on the channel assessment feedback may include any configuration regarding the channel assessment feedback. For example, the configuration information on the channel assessment feedback may comprise at least one of a category of the channel assessment feedback and transmission resources for the channel assessment feedback.

The configuration information on the channel assessment feedback may indicate a specific category of the channel assessment feedback. For example, it may indicate whether the channel assessment feedback is needed. As another example, it may indicate whether the channel assessment feedback supports unaligned transmission or not. As a further example, it may indicate whether beam sweeping feedback mode is enabled, wherein one or more directional channel assessment feedbacks are transmitted back to the gNB on one or more beams. As a still further example, it may further indicate the content type of the channel assessment feedback, for example, a confirmation-ACK or differential CQI. For details about the configuration information on the channel assessment feedback, please refer to Table 1, FIGS. 12 to 15.

In addition, channel measurement activation information can be contained in the channel assessment feedback request to indicate whether the channel assessment feedback is active for the destination device. For example, one bit in Downlink Control information (DCI) can be used to carry the channel measurement activation information. As another example, the channel measurement activation information can also be carried through a higher layer (e.g., Media Access Control (MAC) Control Element (CE) or Radio Resource Control (RRC) signaling). If the destination device detects that the channel assessment feedback is active, it may decode the control information in the common region; if the channel assessment feedback is inactive, it may discard the control information.

The common region may further comprise scheduling DCI containing for example Modulation and Coding Scheme (MCS) level, Hybrid Automatic Repeat Request (HARQ) identity, codewords, and other information usually contained in the scheduling DCI. In addition, it may further comprise duration information for the data transmission.

Next, in step 1902, the destination device may measure, in response to the channel assessment feedback request, channel state on the unlicensed. The destination device decodes the control information, or optional CSI-RS or coded data as indicated by the configuration information in the channel assessment feedback request and assesses the channel state. The channel state measurement or assessment is a known technology and thus will not be elaborated herein.

In step 1903, the destination device may transmit, to the originating device, a channel assessment feedback indicating the channel state measured by the destination device on the unlicensed band, wherein the data transmission from the originating device is dependent on the channel state indicated by the channel assessment feedback.

The channel assessment feedback may in any suitable form. In an embodiment of the represent disclosure, the channel assessment feedback may comprise acknowledge that confirms a good channel state on the unlicensed band. That is to say, if the destination device could decode the information contained in the channel assessment feedback request successfully, it will send an ACK to the originating device; otherwise a NACK is fed back or alternative no any response is transmitted. In another embodiment of the present disclosure, the channel assessment feedback may comprise differential channel quality information which indicates a difference between initially indicated channel quality and channel quality measured by the destination device. For example, if the destination device can decode successfully with MCS level lower than the initially indicated MCS level, the destination device could report the MCS level difference as the differential CQI to the originating device. Upon receipt of such differential CQI, the originating device may transmit the data on the unlicensed band at the channel quality measured by the destination device, for example as illustrated in FIGS. 16 and 17.

In a further embodiment of the present disclosure, the channel assessment feedback may be scrambled by an unlicensed band identity (for example, UB-RNTI) and contain duration information for the data transmission in the channel assessment feedback. That means all NR unlicensed band stations (gNB and terminals) can decode the information in UB-DCI or UB-UCI. Moreover, the scrambling and the duration information can be applied for both UB-DCI and UB-UCI. In addition, the channel assessment feedback may also have UBSS inserted before the UB-DCI and UB-UCI for time alignment, wherein the sequence for UBSS generated by UB-RNTI could be same as that for UB-DCI or UB-UCI. It is further possible to trigger the beam sweeping mode as illustrated in FIG. 18B so that the channel assessment feedback may contain one or more directional channel assessment feedbacks. In such a way, before the transmission starts between node A and UE 1, Node B can learn the transmission and avoid a transmission to UE 2 during the transmission between Node A and UE1.

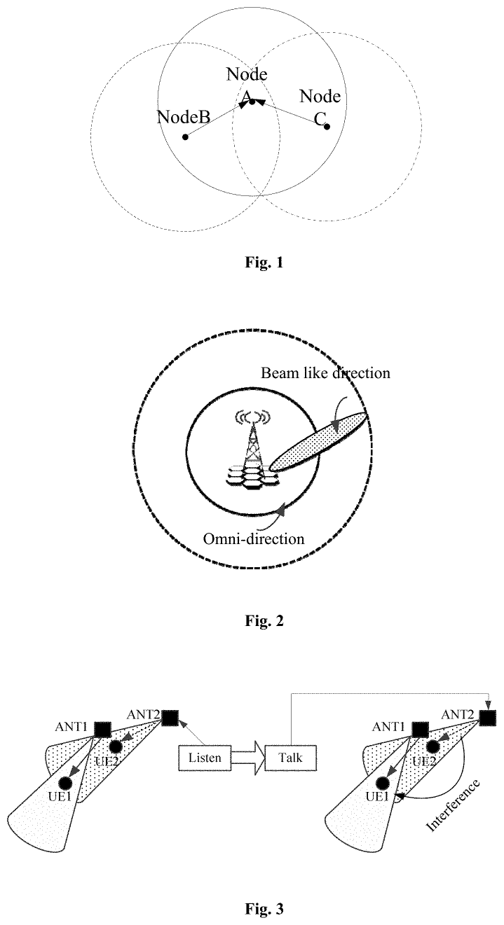

Hereinabove, embodiments of the method of data transmission on unlicensed band at the destination device are described in brief hereinbefore with reference to FIG. 19. However, it can be understood that operations at the destination device are corresponding to those at the originating device and thus for some details of operations, one may refer to description with reference to FIGS. 1 to 18B.

FIG. 20 further schematically illustrates a block diagram of an apparatus for data transmission on an unlicensed band in a wireless communication system according to an embodiment of the present disclosure. The apparatus 2000 can be performed at an originating device. For the downlink data transmission, the originating device could be a network node like gNB, or other network devices; for an uplink data transmission, the originating device could be a terminal device, for example UE, or other like terminal devices.

As illustrated in FIG. 20, the apparatus 2000 may include a request transmission module 2001 and a feedback receiving module 2002. The request transmission module 2001 can be configured to transmit a channel assessment feedback request to a destination device after a successful Clear Channel Access (CCA) on the unlicensed band. The channel assessment feedback request contains at least one of configuration information on the channel assessment feedback request and configuration information on a channel assessment feedback in a common control information region. The feedback receiving module 2002 may be configured to receive, from the destination device, a channel assessment feedback indicating channel state measured by the destination device on the unlicensed band, wherein the data transmission on the unlicensed band is dependent on the channel state indicated by the channel assessment feedback.

In an embodiment of the present disclosure, the channel assessment feedback request further contains channel measurement activation information indicating whether the channel assessment feedback is active for the destination device.

In another embodiment of the present disclosure, the apparatus 2000 may further comprise an indication transmission module 2003, which may be configured to transmit, through a higher layer, channel measurement activation information indicating whether the channel assessment feedback is active for the destination device to the destination device.

In a further embodiment of the present disclosure, the configuration information on the channel assessment feedback request may contain at least one of a category of the channel assessment feedback request and transmission resources of the channel assessment feedback request.

In still further embodiment of the present disclosure, the configuration information on the channel assessment feedback may contain at least one of a category of the channel assessment feedback and transmission resources for the channel assessment feedback.

In yet further embodiment of the present disclosure, the channel assessment feedback request may further contain duration information for the data transmission.

In an embodiment of the present disclosure, the channel assessment feedback request further contains at least one of a reference signal for channel measurement by the destination device; a segment of coded data for channel measurement by the destination device; and an unlicensed band synchronization signal for time alignment by the destination device.

In another embodiment of the present disclosure, the channel assessment feedback may contain acknowledge that confirms a good channel state on the unlicensed band. Or alternatively, the channel assessment feedback may contain differential channel quality information which indicates a difference between initially indicated channel quality and channel quality measured by the destination device, wherein the data is transmitted on the unlicensed band at the channel quality measured by the destination device.

In a further embodiment of the present disclosure, the channel assessment feedback may further by the destination device one or more directional channel assessment feedbacks.

In a still further embodiment of the present disclosure, the channel assessment feedback may be scrambled by an unlicensed band identity, and wherein the channel assessment feedback may further contain duration information for the data transmission.

In a yet further embodiment of the present disclosure, the channel assessment feedback may contain an unlicensed band synchronization signal.

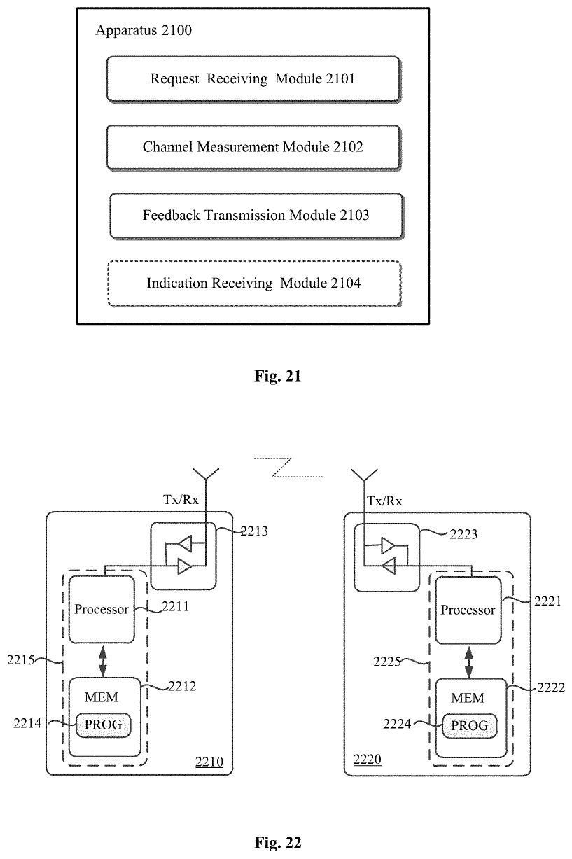

FIG. 21 further schematically illustrates a block diagram of an apparatus for data transmission on an unlicensed band in a wireless communication system according to an embodiment of the present disclosure. The apparatus 2100 may be performed at a destination device. For a downlink data transmission, the destination device could be a terminal device, for example UE, or other like terminal devices; for an uplink data transmission, the destination device could be a network node like gNB, or other network devices.

As illustrated in FIG. 21, the apparatus 2100 may include a request receiving module 2101, a channel measurement module 2102 and a feedback transmission module 2103. The request receiving module 2101 may be configured to receive a channel assessment feedback request from an originating device, wherein the channel assessment feedback request contains at least one of configuration information on the channel assessment feedback request and configuration information on a channel assessment feedback in a common control information region. The channel measurement module 2102 may be configured to measure, in response to the channel assessment feedback request, the channel state on the unlicensed band. The feedback transmission module 2103 may be configured to transmit, to the originating device, a channel assessment feedback indicating the channel state measured by the destination device on the unlicensed band, wherein the data transmission from the originating device is dependent on the channel state indicated by the channel assessment feedback.

In an embodiment of the present disclosure, the channel assessment feedback request may further contain channel measurement activation information indicating whether the channel assessment feedback is active for the destination device.

In another embodiment of the present disclosure, the apparatus 2100 may further comprise an indication receiving module 2104. The indication receiving module 2104 may be configured to receive, through a higher layer, channel measurement activation information indicating whether the channel assessment feedback is active for the destination device from the originating.

In a further embodiment of the present disclosure, the configuration information on the channel assessment feedback request may contain at least one of a category of the channel assessment feedback request and transmission resources of the channel assessment feedback request.

In a still further embodiment of the present disclosure, the configuration information on the channel assessment feedback may contain at least one of a category of the channel assessment feedback and transmission resources for the channel assessment feedback.

In a yet further embodiment of the present disclosure, the channel assessment feedback request may further contain duration information for the data transmission.

In an embodiment of the present disclosure, the channel assessment feedback request may further contain at least one of a reference signal for channel measurement by the destination device; a segment of coded data for channel measurement by the destination device; and an unlicensed band synchronization signal for time alignment by the destination device.

In another embodiment of the present disclosure, the channel assessment feedback may contain any of acknowledge that confirms a good channel state on the unlicensed band; and differential channel quality information which indicates a difference between initially indicated channel quality and channel quality measured by the destination device.

In a further embodiment of the present disclosure, the channel assessment feedback may further contain one or more directional channel assessment feedbacks.

In a still further embodiment of the present disclosure, the channel assessment feedback may be scrambled by an unlicensed band identity, and wherein the channel assessment feedback may further contain duration information for the data transmission.

In a yet further embodiment of the present disclosure, the channel assessment feedback may further contain an unlicensed band synchronization signal.

Hereinbefore, apparatuses 2000 and 2100 are described with reference to FIGS. 20 and 21 in brief. It can be noted that the apparatuses 2000 and 2100 may be configured to implement functionalities as described with reference to FIGS. 1 to 19. Therefore, for details about the operations of modules in these apparatuses, one may refer to those descriptions made with respect to the respective steps of the methods with reference to FIGS. 1 to 19.

It is further noted that components of the apparatuses 2000 and 2100 may be embodied in hardware, software, firmware, and/or any combination thereof For example, the components of apparatuses 2000 and 2100 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 2000 and 2100 may include at least one processor. The at least one processor suitable for use with embodiments of the present disclosure may include, by way of example, both general and special purpose processors already known or developed in the future. Apparatuses 2000 and 2100 may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 2000 and 2100 to at least perform operations according to the method as discussed with reference to FIGS. 1 to 19 respectively.

FIG. 22 further illustrates a simplified block diagram of an apparatus 2210 that may be embodied as or comprised in an originating device of a data transmission on an unlicensed band, and an apparatus 2220 that may be embodied as or comprised in a destination device of a data transmission on the unlicensed band as described herein. For a downlink data transmission, the originating device could be a network node like gNB, or other network devices and the destination device could be a terminal device, for example UE, or other like terminal devices. For an uplink data transmission, the originating device could be a terminal device, for example UE, or other like terminal devices, the destination device could be a network node like gNB, or other network devices.

The apparatus 2210 comprises at least one processor 2211, such as a data processor (DP) and at least one memory (MEM) 2212 coupled to the processor 2211. The apparatus 2210 may further include a transmitter TX and receiver RX 2213 coupled to the processor 2211, which may be operable to communicatively connect to the apparatus 2220. The MEM 2212 stores a program (PROG) 2214. The PROG 2214 may include instructions that, when executed on the associated processor 2211, enable the apparatus 2210 to operate in accordance with embodiments of the present disclosure, for example method 700. A combination of the at least one processor 2211 and the at least one MEM 2212 may form processing means 2215 adapted to implement various embodiments of the present disclosure.

The apparatus 2220 comprises at least one processor 2221, such as a DP, and at least one MEM 2222 coupled to the processor 2221. The apparatus 2220 may further include a suitable TX/RX 2223 coupled to the processor 2221, which may be operable for wireless communication with the apparatus 2210. The MEM 2222 stores a PROG 2224. The PROG 2224 may include instructions that, when executed on the associated processor 2221, enable the apparatus 2220 to operate in accordance with the embodiments of the present disclosure, for example to perform method 1900. A combination of the at least one processor 2221 and the at least one MEM 2222 may form processing means 2225 adapted to implement various embodiments of the present disclosure.

Various embodiments of the present disclosure may be implemented by computer program executable by one or more of the processors 2211, 2221, software, firmware, hardware or in a combination thereof.

The MEMs 2212 and 2222 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 2211 and 2221 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method, comprising:
transmitting a channel assessment feedback request to a destination device after a successful Clear Channel Access (CCA) on the unlicensed band, wherein the channel assessment feedback request contains at least one of configuration information on the channel assessment feedback request and configuration information on a channel assessment feedback in a common control information region; and
receiving, from the destination device, a channel assessment feedback indicating channel state measured by the destination device on the unlicensed band, wherein the data transmission on the unlicensed band is dependent on the channel state indicated by the channel assessment feedback.

2. The method of claim 1, wherein the channel assessment feedback request further contains channel measurement activation information indicating whether the channel assessment feedback is active for the destination device.

3. The method of claim 1, further comprising:
transmitting, through a higher layer, channel measurement activation information indicating whether the channel assessment feedback is active for the destination device to the destination device.

4. The method of claim 1, wherein the configuration information on the channel assessment feedback request contains at least one of a category of the channel assessment feedback request and transmission resources of the channel assessment feedback request; and/or
wherein the configuration information on the channel assessment feedback contains at least one of a category of the channel assessment feedback and transmission resources for the channel assessment feedback.

5. The method of claim 1, wherein the channel assessment feedback request further contains duration information for the data transmission.

6. The method of claim 1, wherein the channel assessment feedback request further contains at least one of
a reference signal for channel measurement by the destination device;
a segment of coded data for channel measurement by the destination device; and
an unlicensed band synchronization signal for time alignment by the destination device.

7. The method of claim 1, wherein the channel assessment feedback contains any of:
acknowledge that confirms a good channel state on the unlicensed band; and
differential channel quality information which indicates a difference between initially indicated channel quality and channel quality measured by the destination device, wherein the data is transmitted on the unlicensed band at the channel quality measured by the destination device.

8. The method of claim 1, wherein the channel assessment feedback further contains one or more directional channel assessment feedbacks.

9. The method of claim 1, wherein the channel assessment feedback is scrambled by an unlicensed band identity, and the channel assessment feedback further contains duration information for the data transmission; and
wherein the channel assessment feedback contains an unlicensed band synchronization signal.

10. (canceled)

11. A method for data transmission on an unlicensed band in a wireless communication system, comprising:
receiving a channel assessment feedback request from an originating device, wherein the channel assessment feedback request contains at least one of configuration information on the channel assessment feedback request and configuration information on a channel assessment feedback in a common control information region; and
measuring, in response to the channel assessment feedback request, channel state on the unlicensed band; and
transmitting, to the originating device, a channel assessment feedback indicating the channel state measured by the destination device on the unlicensed band, wherein the data transmission from the originating device is dependent on the channel state indicated by the channel assessment feedback.

12. The method of claim 11, wherein the channel assessment feedback request further contains channel measurement activation information indicating whether the channel assessment feedback is active for the destination device.

13. The method of claim 11, further comprising:
receiving, through a higher layer, channel measurement activation information indicating whether the channel assessment feedback is active for the destination device from the originating device.

14. The method of claim 11, wherein the configuration information on the channel assessment feedback request contains at least one of a category of the channel assessment feedback request and transmission resources of the channel assessment feedback request; and/or
wherein the configuration information on the channel assessment feedback contains at least one of a category of the channel assessment feedback and transmission resources for the channel assessment feedback.

15. The method of claim 11, wherein the channel assessment feedback request further contains duration information for the data transmission.

16. The method of claim 11, wherein the channel assessment feedback request further contains at least one of
a reference signal for channel measurement by the destination device;
a segment of coded data for channel measurement by the destination device; and
an unlicensed band synchronization signal for time alignment by the destination device.

17. The method of claim 11, wherein the channel assessment feedback contains any of:
acknowledge that confirms a good channel state on the unlicensed band; and
differential channel quality information which indicates a difference between initially indicated channel quality and channel quality measured by the destination device.

18. The method of claim 11, wherein the channel assessment feedback further contains one or more directional channel assessment feedbacks.

19. The method of claim 11 wherein the channel assessment feedback is scrambled by an unlicensed band identity, and the channel assessment feedback further contains duration information for the data transmission;
wherein the channel assessment feedback further contains an unlicensed band synchronization signal.

20. (canceled)

21. A device, comprising
a transceiver configured to:
transmit a channel assessment feedback request to a destination device after a successful Clear Channel Access (CCA) on the unlicensed band, wherein the channel assessment feedback request contains at least one of configuration information on the channel assessment feedback request and configuration information on a channel assessment feedback in a common control information region;
receive, from the destination device, a channel assessment feedback indicating channel state measured by the destination device on the unlicensed band, wherein the data transmission on the unlicensed band is dependent on the channel state indicated by the channel assessment feedback.

22. The device of claim 21, where the channel assessment feedback request further contains channel measurement activation information indicating whether the channel assessment feedback is active for the destination device; and/or
wherein the transceiver is further configured to: transmit, through a higher layer, channel measurement activation information indicating whether the channel assessment feedback is active for the destination device to the destination device; and/or
wherein the channel assessment feedback request further contains duration information for the data transmission.

23-32. (canceled)
